(19) United States
(12) Patent Application Publication
(10) Pub. No.: US 2004/0069963 A1
(43) Pub. Date: Apr. 15, 2004

(54) Valve for controlling fluids

(75) Inventors: Patrick Mattes, Stuttgart (DE); Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 10/252,572

(22) Filed: Sep. 24, 2002

(30) Foreign Application Priority Data
Sep. 26, 2001 (DE) 1 01 47 483.0

(51) Int. Cl. F16K 31/12

(52) U.S. Cl. 251/57; 239/102.2

(57) ABSTRACT

A valve for controlling fluids includes a valve housing in which an actuator chamber is embodied, in which chamber a piezoelectric actuator module for actuating a valve member that is axially displaceable in a valve body is disposed, which valve member has an adjusting piston upon which the actuator module acts and also has an actuating piston which is operatively connected to the adjusting piston via a hydraulic coupler and which is in contact with a valve closing member, disposed in a valve chamber, that cooperates with at least one valve seat and downstream thereof a diversion conduit branches off. An axially acting first prestressing spring engages the actuator module, and the adjusting piston is loaded in the direction of the actuator module.

### BACKGROUND OF THE INVENTION

1. Field of the Invention

The invention is directed to an improved valve for controlling fluids, and more particularly to an improved fuel injector valve for use in an internal combustion engine.

2. Description of the Prior Art

One valve fo this type with which this invention is concerned is known in the industry and is used for instance in a fuel injection valve, in particular a common rail injector, in a motor vehicle.

A valve of the type referred to at the outset is also known from European Patent Disclosure EP 0 477 400 A1. For actuation, this valve has a piezoelectric actuator. A deflection of the actuator upon actuation of the valve is transmitted to a valve closing member via a hydraulic chamber, which functions as a hydraulic booster or coupling and tolerance compensation element. The hydraulic chamber is disposed here between an adjusting piston, coupled to the piezoelectric actuator, and an actuating piston, connected to the valve closing member, and thus functions as a hydraulic coupler. The adjusting piston has a larger diameter than the actuating piston, and thus the actuating piston executes a stroke that is lengthened by the boosting ratio of the piston diameters when the adjusting piston, by means of the piezoelectric actuator, experiences a certain deflection.

In practice, the hydraulic chamber is designed such that leaks that occur during operation can be compensated for by refilling. To this end, a fluid pressure or so-called system pressure acts on the hydraulic chamber, for instance via leakage gaps.

The valve closing member, which is connected to the actuating piston, is disposed in a valve chamber and cooperates with a valve seat in such a way that upon opening of the valve closing member, a fluid flow to a diversion conduit that branches off downstream of the valve closing member is controllable.

The piezoelectric actuator, which is associated with an actuator module and which furthermore has an actuator foot and an actuator head, must be loaded for pressure by means of a prestressing element, in order to prevent it from being destroyed during operation. The requisite prestressing, which is in the range of 800 N, has until now been introduced into the piezoelectric actuator by means of a tubular spring via the adjusting piston. In the process, transverse forces in the range of 30 N to 70 N act on the adjusting piston. Because of these transverse forces, major fluctuations from one example to another occur, which when the valve is used in a fuel injector lead to major differences in the injection quantity. Moreover, the transverse forces cause wear to the valve in the region of a guide for the adjusting piston, which can sometimes lead to failure of the valve.

### OBJECTION AND SUMMARY OF THE INVENTION

The valve for controlling fluids according to the invention, in which an axially acting first prestressing spring engages the actuator module and the adjusting piston is loaded in the direction of the actuator module, has the advantage that a prestressing element engages the actuator module directly, and the transverse forces acting on the adjusting piston are thus only slight. A nonpositive engagement between the actuator module and the adjusting piston occurs as a result of the loading of the adjusting piston in the direction of the actuator module, so that upon axial lengthening of the actuator module, a transmission of force to the actuating piston is assured by means of the hydraulic coupler.

The valve according to the invention is especially embodied for use in a fuel injection valve of a Diesel internal combustion engine.

The actuator module, which is disposed in the actuator chamber of the valve housing, is loaded for pressure for instance by means of a spiral spring, which forms the first prestressing spring and which can be braced on the valve body, which can be constructed in one or more parts and in which the pistons are guided.

Minimizing the transverse forces acting on the booster piston results in improved wear performance of the valve compared to the prior art. Moreover, the low transverse forces acting on the adjusting piston, which can range between 3 and 5 N, lead to a reduction in tolerances in terms of fuel quantity, specifically because defined force conditions prevail at the hydraulic booster, which includes the adjusting piston, the hydraulic coupler and the actuating piston.

In a special embodiment of the valve of the invention, the adjusting piston is loaded in the direction of the actuator module by means of a second prestressing spring, which may be embodied as a helical spring or spiral spring. As a result, refilling of the hydraulic coupler is unimpaired, since the adjusting piston always rests on the actuator module. The spring force of the second prestressing spring is about 50 N, for instance. The second prestressing spring can also be braced on the valve body and engage a support plate that is connected to the adjusting piston.

In an alternative embodiment of the valve of the invention, the actuator chamber is pressure-relieved, so that a pressure drop occurs between the hydraulic coupler and the actuator chamber, and the adjusting piston is loaded in the direction of the actuator module by means of the pressure operative in the hydraulic coupler. Because of this provision, pressure cannot build up in the actuator chamber; hence that actuator module is not exposed to any diversion surges, and the risk of damage to the actuator module and thus of failure of the valve is minimized. Moreover, in this embodiment, the piston and valve body can be mounted in a way that is low in transverse force, since the adjusting piston is prestressed only hydraulically, and only when fuel is introduced into the hydraulic coupler embodied as a hydraulic chamber.

The diversion conduit is advantageously embodied on a valve plate that surrounds the valve seat. As a rule, the valve plate adjoins the valve body, in which the adjusting piston and the actuating piston are guided and in which the hydraulic coupler is disposed. Because the diversion conduit is disposed in the valve plate, the diversion quantity is rerouted, specifically directly into a diversion bore embodied for instance in the valve housing. It is as a result essentially impossible for so-called diversion surges to act on the actuator module.

### BRIEF DESCRIPTION OF THE DRAWINGS

The invention will be better understood and further objects and advantages thereof will become more apparent from the ensuing detailed description of preferred embodiments taken in conjunction with the drawings, in which

FIG. 1 schematically shows a valve of the invention in longitudinal section, embodied for use in a common rail injector; and

FIG. 2 shows an alternative embodiment of a valve of the invention, in a view corresponding to FIG. 1.

### DESCRIPTION OF THE PREFERRED EMBODIMENTS

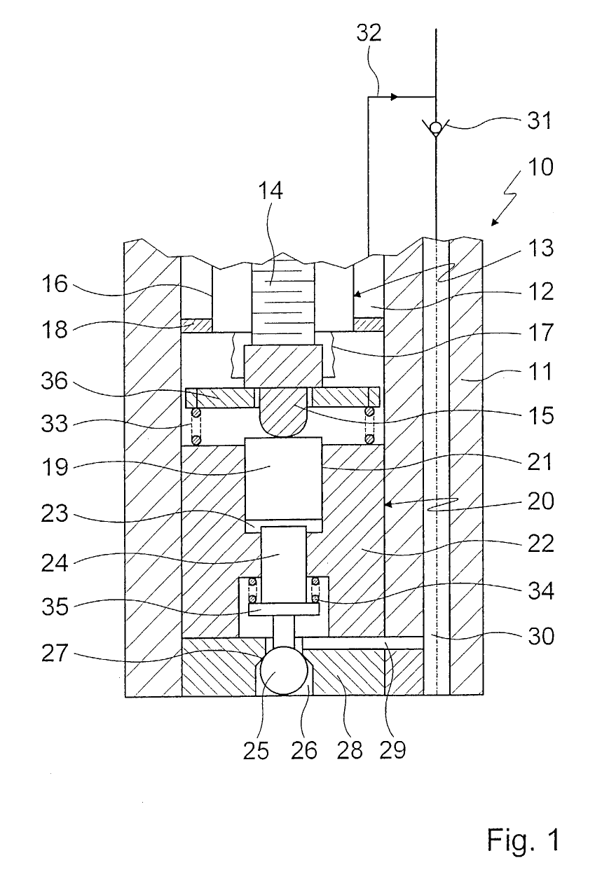

In FIG. 1, a valve 10 for controlling fluids is shown in a fuel injection valve for a Diesel internal combustion engine of a motor vehicle. The valve 10 serves as a control module for a nozzle module, not shown in detail here, of the fuel injection valve.

The nozzle module adjoins the control module in the axial direction and includes a nozzle needle, disposed and guided in a nozzle body, that controls openings of the nozzle body that lead to an engine combustion chamber.

The nozzle needle and the valve control piston form a structural unit that adjoins a so-called valve control chamber. Via the pressure level prevailing in the valve control chamber, the position of the valve control piston and thus the position of the nozzle needle are adjusted. The pressure level in the valve control chamber is adjusted by means of the control module or valve 10 shown in FIG. 1.

The valve or control module 10 includes a valve housing 11, in which an actuator chamber 12 is embodied, in which actuator chamber an actuator module 13 is disposed that serves to actuate the valve 10.

The actuator module 13 includes a piezoelectric actuator 14 braced on the valve housing 11 via an actuator foot, not shown in detail here, and also includes an actuator head 15, connected to the actuator 14, and a sleeve 16 for sealing purposes. In the region of the actuator head 15, the actuator module 13 moreover has a bellows 17, which can absorb an axial lengthening of the actuator and which furthermore also has a sealing function. For radial fixation, the actuator module 13 furthermore has an adjusting ring 18, which embraces the sleeve 16 and radially adjoins the valve housing 11.

In the axial direction, the actuator head 15 is adjoined, on the face end remote from the piezoelectric actuator 14, by an adjusting piston 19, which is associated with a coupler module 20 and is guided axially displaceably in a cylindrical bore 21 of a valve body 22 that is also associated with the coupler module 20. The valve body 22 radially adjoins the valve housing 11.

The adjusting piston 19 is operatively connected, via a hydraulic chamber 23 embodied as a hydraulic coupler, with an actuating piston 24, which is connected in turn to a valve closing member 25 that serves to regulate the pressure level in the valve control chamber of the nozzle module and is disposed in a valve chamber 26. The valve closing member 25 cooperates with a valve seat 27, which is embodied on a valve plate 28, which in the axial direction adjoins the valve body 22, on the face end remote from the actuator module 13, and the nozzle module, on the opposed face end.

On the face end toward the valve body 22, a groove 29 embodied as a diversion conduit is disposed on the valve plate 28; it leads to a diversion bore 30 disposed in the valve housing 11. The diversion bore 30 serves as a return conduit and leads to a fuel tank, not shown in detail here, via a check valve 31. The check valve 31 opens at a pressure of about 30 bar, so that downstream of the valve closing member 25, a system pressure of about 30 bar prevails.

From the actuator chamber 12, a conduit 32 branches off, which discharges downstream of the check valve 31 into the diversion bore 30, or into a line communicating with the diversion bore 30. The actuator chamber 12 is thus pressure-relieved.

The valve 10 furthermore has a plate 36, which is connected to the actuator head 15 and is engaged by a helical spring 33, which is braced on the valve body 22 of the coupler module 20, so that the piezoelectric actuator 14 is prestressed in the direction remote from the adjusting piston 19. The prestressing amounts to about 800 N.

The actuating piston 24 is in turn prestressed in the direction of the valve closing member 25, by means of a helical spring 34, which is likewise braced on the valve body 22 and which engages a plate 35.

In the valve shown in FIG. 1, the so-called system pressure of about 30 bar prevails in the hydraulic chamber 23, while conversely, in the actuator chamber 12 that is relieved via the line 32, a so-called leak fuel pressure of about 1 bar prevails. Because of this pressure drop, the adjusting piston 19 is loaded in the direction of the actuator module 13. The adjusting piston 19 thus rests on the face end of the actuator head 15. Refilling of the hydraulic chamber is thus assured.

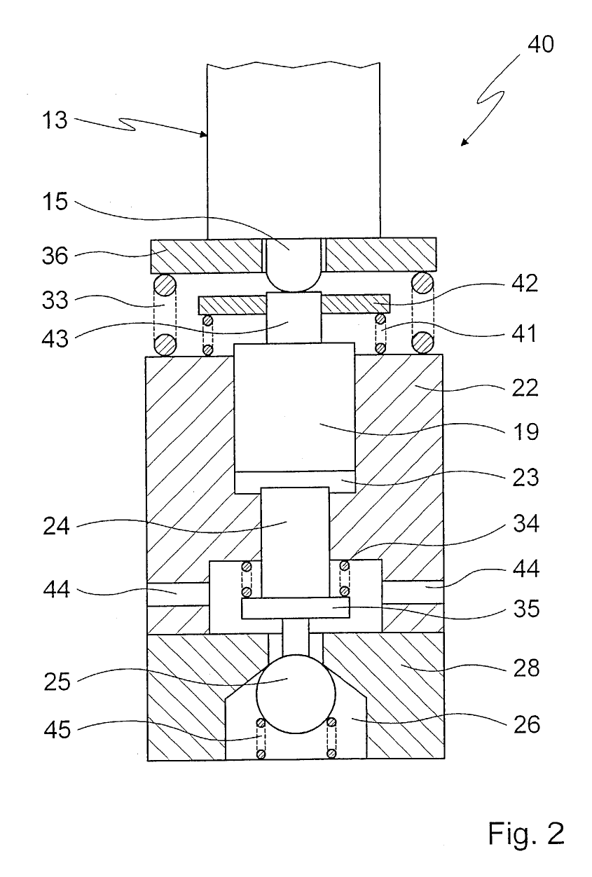

In FIG. 2, a second embodiment of a valve 40 for controlling fluids is shown in fragmentary form; once again, it is embodied for use in a fuel injection valve of a Diesel internal combustion engine of a motor vehicle.

The valve 40, which is shown in FIG. 2 without a valve housing, differs from the valve of FIG. 1 in that loading of the adjusting piston 19, associated with the coupler module 20, occurs in the direction of the actuator head 15 by means of a helical spring 41, which is braced on the valve body 22 and engages a support plate 42 that is connected to a boltlike protrusion 43 of the adjusting piston 19. As a result, the piston 19 is prestressed in the direction of the actuator module 13. The face end, remote from the actuating piston 24, of the boltlike protrusion 43 of the adjusting piston 19 thus always rests on the actuator head 15.

Also in the valve 40 of FIG. 2, the valve body 22 of the coupler module 20 is provided with diversion conduits 44, which lead to a return conduit or a fuel tank. The valve plate 28, in which the valve chamber 26 for the valve closing member 25 is disposed, rests with its full surface on the valve body 22.

By means of a further spring 45, which is braced on the nozzle module, not shown here, the valve closing member 25 is loaded in the direction of the actuating piston 24, or in other words in the closing direction.

The foregoing relates to preferred exemplary embodiments of the invention, it being understood that other variants and embodiments thereof are possible within the spirit and scope of the invention, the latter being defined by the appended claims.

We claim:

1. In a valve for controlling fluids, having a valve housing (11) in which an actuator chamber (12) is embodied and in which chamber a piezoelectric actuator module (13) for actuating a valve member which is axially displaceable in a valve body (22) is disposed, which valve member has an adjusting piston (19), upon which the actuator module (13) acts, and has an actuating piston (24), which is operatively connected to the adjusting piston (19) via a hydraulic coupler (23) and is in contact with a valve closing member (25), disposed in a valve chamber (26), that cooperates with at least one valve seat (27) and downstream thereof a diversion conduit (29, 44) branches off, the improvement comprising an axially acting first prestressing spring (33) engaging the actuator module (13), and the adjusting piston (19) being loaded in the direction of the actuator module (13).

2. The valve of claim 1, wherein the adjusting piston (19) is loaded in the direction of the actuator module (13) by means of a second prestressing spring (41).

3. The valve of claim 2, wherein the second prestressing spring (41) is braced on the valve body (22) and engages a support plate (42) connected to the adjusting piston (19).

4. The valve of claim 1, wherein the actuator chamber (12) is pressure-relieved, so that a pressure drop occurs between the hydraulic coupler (23) and the actuator chamber (12), and the adjusting piston (19) is loaded in the direction of the actuator module (13) by means of the pressure operative in the hydraulic coupler (23).

5. The valve of claim 2, wherein the actuator chamber (12) is pressure-relieved, so that a pressure drop occurs between the hydraulic coupler (23) and the actuator chamber (12), and the adjusting piston (19) is loaded in the direction of the actuator module (13) by means of the pressure operative in the hydraulic coupler (23).

6. The valve of claim 3, wherein the actuator chamber (12) is pressure-relieved, so that a pressure drop occurs between the hydraulic coupler (23) and the actuator chamber (12), and the adjusting piston (19) is loaded in the direction of the actuator module (13) by means of the pressure operative in the hydraulic coupler (23).

7. The valve of claim 4, further comprising a relief conduit (32), which branches off from the actuator chamber (12) and discharges, downstream of a check valve (31) that is disposed in a diversion line (30) communicating with the diversion conduit (29), into the diversion bore (30).

8. The valve of claim 1, wherein the first prestressing spring (33) is braced on the valve body (22).

9. The valve of claim 2, wherein the first prestressing spring (33) is braced on the valve body (22). body (22).

10. The valve of claim 4, wherein the first prestressing spring (33) is braced on the valve body (22). body (22).

11. The valve of claim 1, wherein the first prestressing spring (33) engages the actuator module (13) via a plate 32 connected to the actuator module (13).

12. The valve of claim 2, wherein the first prestressing spring (33) engages the actuator module (13) via a plate 32 connected to the actuator module (13).

13. The valve of claim 4, wherein the first prestressing spring (33) engages the actuator module (13) via a plate 32 connected to the actuator module (13).

14. The valve of claim 1, wherein the diversion conduit (29) is embodied on a valve plate (28) that surrounds the valve seat (27).

15. The valve of claim 2, wherein the diversion conduit (29) is embodied on a valve plate (28) that surrounds the valve seat (27).

16. The valve of claim 14, wherein the diversion conduit is formed by a groove (29), which is embodied on a face end, toward the valve body (22), of the valve plate (28).

17. The valve of claim 1, wherein the actuating piston (24) is prestressed in the direction of the valve closing member (25) by means of a third prestressing spring (34), which is braced on the valve body (22).

18. The valve of claim 2, wherein the actuating piston (24) is prestressed in the direction of the valve closing member (25) by means of a third prestressing spring (34), which is braced on the valve body (22).

19. The valve of claim 4, wherein the actuating piston (24) is prestressed in the direction of the valve closing member (25) by means of a third prestressing spring (34), which is braced on the valve body (22).

20. The valve of claim 7, wherein the actuating piston (24) is prestressed in the direction of the valve closing member (25) by means of a third prestressing spring (34), which is braced on the valve body (22).
